(19) United States
(12) Patent Application Publication
(10) Pub. No.: US 2026/0260007 A1
(43) Pub. Date: Sep. 3, 2026

(54) PLUGIN-BASED SECRETS MANAGEMENT WITH AUTOMATED ROTATION AND POLICY ENFORCEMENT

(71) Applicant: NVIDIA Corporation, Santa Clara, CA (US)

(72) Inventors: Abhinav CHANDA, Sunnyvale, CA (US); Phani Bhushan AVADHANAM, San Diego, CA (US)

(21) Appl. No.: 19/066,798

(22) Filed: Feb. 28, 2025

(51) Int. Cl. G06F 21/62

(52) U.S. Cl. CPC G06F 21/6218; G06F 21/604

(57) ABSTRACT

In various examples, systems and methods are disclosed related to plugin-based secrets management with automated rotation and policy enforcement. In particular, a secrets management system may include a monitoring or auditing system that enables various management functionalities, including management or enforcement of policies, rotations or lifecycles, access, and secret generation. As such, the secrets management system as described herein integrates effective monitoring capabilities while maintaining the highest security standards, enabling management of secrets at scale without compromising performance or security. In some embodiments, the secrets management system is configured to perform such management functionalities using a plugin(s), for example, that executes via a secrets manager of the secrets management system.

### BACKGROUND

Secrets management systems are used to securely store and manage sensitive information or secrets, such as database passwords, API keys, certificates, and authentication tokens. Such systems are generally designed to ensure that secrets are protected from unauthorized access and are used securely by applications and services, thereby preventing leaks and unauthorized access.

Conventional secrets management systems, however, rely on manual processes. For example, an organization, or portion thereof, may onboard a secrets management system, retrieve the necessary credentials, and then handle secure storage and lifecycle management. Further, internal security policies may exist in association with various secrets, such as policies indicating that secrets should not be stored in plaintext files, shared in unsecured locations, retained indefinitely, and/or the like. Using manual approaches, however, compliance with the policies may be time consuming, tedious, and inconsistent. For example, manual audits may be slow, resource-intensive, and unreliable, making it difficult to verify whether secrets have been rotated within the required timeframes (e.g., every 90 or 180 days). Furthermore, different secrets have varying expiration timelines, ranging from minutes to months, adding complexity to manual tracking efforts. As another example, manual rotation of secrets may be performed by a team (e.g., a Site Reliability Engineering team) by authenticating with the secrets issuer, retrieving a new secret, and updating it in the secrets store. Such a disjointed and manual process may result in inefficiencies, security gaps, and operational overhead.

Further, organizations may have hundreds of thousands of secrets across numerous internal services and products. Such secrets may take various forms, including Kubernetes secrets, GitLab tokens, AWS API keys, and x509 certificates. Managing such a vast and diverse set of secrets manually is impractical and introduces risks, such as service downtime when expired credentials go unnoticed. Additionally, many existing systems follow a flat, hierarchical permission model where access is granted broadly, such as to an entire email distribution list. This widespread access increases the risk of unauthorized usage or leaks, ultimately weakening the organization's security posture.

In accordance with the challenges of manually managing a vast and diverse set of secrets, existing secrets management solutions lack effectiveness in regard to various aspects of secrets management, such as monitoring, policy enforcement, and/or proactive security measures. For example, conventional secrets management systems lack automated monitoring capabilities, thereby making it difficult to proactively identify vulnerabilities without exposing sensitive information. Ineffective monitoring impacts policy enforcement, rotation management, access management, and secret generation. For example, conventional secrets management systems oftentimes rely on periodic manual audits, which are time-consuming, prone to human error, and reactive. With periodic manual audits, policy enforcement may be unreliable as violations (e.g., secrets stored in unauthorized locations or shared with unintended users) may go undetected for long periods of time, thereby increasing security risks.

With regard to rotation management, ineffective monitoring can lead to expired or compromised secrets remaining in use, as organizations may not detect when rotations fail or when a secret is nearing expiration. Accordingly, the risk of service outages and unauthorized access due to missed or overlooked rotations may increase. Further, in conventional implementations, secret rotations are generally performed manually, leading to delays and operational inefficiencies. For instance, manually updating secrets after expiration results in unusable secrets, thereby leading to downtime for services that rely on secrets stored in a secrets management system to communicate with other services and APIs. In some cases, automated scripts may be used. However, such scripts generally require high-level access to rotate secrets, which introduces an additional security risk.

For access management, ineffective monitoring may result in unauthorized access attempts, misconfigured permissions, etc. In existing secrets management systems, a distribution list may be used to provide authorizations. In cases in which excessive permissions are granted, however, a user or system may have access to more secrets than necessary, thereby resulting in more potential security issues. Further, a lack of real-time visibility into access logs delays any detection and/or responses to potential breaches.

With regard to generation of secrets, a lack of effective monitoring can lead to unused secrets, increasing security concerns. For example, in cases in which a secret is generated but not property recorded or tracked, the secret may not be properly rotated or forgotten, which may potentially expose sensitive data. Further, organizations may not detect when an attacker generates unauthorized secrets.

In addition to increased security risks, compliance violations, and operational failures associated with conventional secrets management systems, implementation of such systems often results in inefficient use of computing resources. For example, in addition to the computing resources used to manually rotate secrets, failing to timely rotate secrets leads to expired secrets, thereby causing downtime for services that rely on them. On the other hand, rotating secrets too frequently can place unnecessary additional load on the infrastructure, increasing latency and reducing performance.

Accordingly, current approaches introduce security risks and/or create operational inefficiencies. In this way, secrets can become vulnerable to breaches, mismanagement, and exposure, thereby resulting in ineffective secrets management.

### SUMMARY

Embodiments of the present disclosure relate to plugin-based secrets management with automated rotation and policy enforcement. Systems and methods are disclosed that perform management of secrets in a proactive manner without exposing sensitive information. In accordance with embodiments described herein, secrets management system may include a monitoring or auditing system that enables various management functionalities, including management or enforcement of policies, rotations or lifecycles, access, and secret generation. In this regard, embodiments described herein enable detection of misuse, unauthorized access, policy violations, and/or the like, without compromising security and performance. As such, the secrets management system as described herein integrates effective monitoring capabilities while maintaining the highest security standards, enabling organizations to manage secrets at scale without compromising performance or security. In some embodiments, the secrets management system is configured to perform such management functionalities using a plugin(s), for example, that executes via a secrets manager of the secrets management system.

In contrast to conventional implementations, facilitating automated management of secrets enables a more scalable, secure, and effective approach to managing secrets. In addition to improved security of secrets and enhanced scalability, computing resource utilization is reduced as less resources may be needed to manage secrets in an automated manner. For example, automated policy enforcement, monitoring, and rotation remove the need for frequent manual checks, thereby reducing CPU cycles and database queries. Further, instead of repeatedly querying or storing secrets in an inefficient way, secrets are only rotated when needed based on TTL and pre-configured thresholds, thereby reducing unnecessary computation involved in continuous polling or excessive secret generation. As another example, a plugin-based approach allows for caching metadata to reduce redundant database queries, thereby reducing the frequency of fetching secrets and read operations as well as lowering overall system load.

### BRIEF DESCRIPTION OF THE DRAWINGS

The present systems and methods for plugin-based secrets management with automated rotation and policy enforcement are described in detail below with reference to the attached drawing figures, wherein:

FIG. 1 provides an example network environment, in accordance with some embodiments of the present disclosure;

FIG. 2 illustrates an example implementation for facilitating management of secrets, in accordance with embodiments described herein;

FIG. 3 provides an example for performing secrets management, in accordance with some embodiments of the present disclosure;

FIG. 4 provides an example method for facilitating management of secrets, in accordance with some embodiments of the present disclosure;

FIG. 5 provides an example method for facilitating management of secrets, in accordance with some embodiments of the present disclosure;

FIG. 6 provides an example method for facilitating management of secrets, in accordance with some embodiments of the present disclosure;

FIG. 7 is a block diagram of an example computing device suitable for use in implementing at least some embodiments of the present disclosure; and

FIG. 8 is a block diagram of an example data center suitable for use in implementing at least some embodiments of the present disclosure.

### DETAILED DESCRIPTION

Systems and methods are disclosed related to plugin-based secrets management with automated rotation and policy enforcement. In particular, secrets are managed in an automated and resource-efficient manner to facilitate proactive monitoring and enhance various secrets management activities, such as policy management, rotation management, access management, and/or secret generation management. In this regard, embodiments described herein enable detection of misuse, unauthorized access, policy violations, and/or the like, without compromising security and performance.

In accordance with embodiments described herein, secrets management system may include a monitoring or auditing system that enables various management functionalities, including management or enforcement of policies, rotations or lifecycles, access, and secret generation. To this end, the secrets management system as described herein integrates effective monitoring capabilities while maintaining the highest security standards, enabling organizations to manage secrets at scale without compromising performance or security. In some embodiments, the secrets management system is configured to perform such management functionalities using a plugin(s), for example, that executes via a secrets manager of the secrets management system. Accordingly, such an enhanced secrets management system may extend functionality of improving automation and enhancing security and scalability without requiring various changes to the core system. For example, new or enhanced features such as automated secret rotation, access controls, or policy compliance may be added as needed. Further, as many organizations use multiple cloud providers and services, each with their own secrets management approach, a plugin may act as an intermediary that standardizes secrets handling across various platforms, thereby ensuring consistent security practices. Further, the automation provided by a plugin reduces human intervention and minimizes likelihood of accidental exposure or misuse of secrets.

In operation, to efficiently and effectively manage secrets, a secrets management system may include a secrets manager that is generally configured to manage secrets stored in a secrets data store. Various secrets may be stored in a secrets data store, such as database credentials, authentication tokens, API keys, certificates, and/or the like. Further, such secrets may correspond with various secrets issuers and/or secrets manager. At a high level, the secrets manager may be responsible for managing access, handling secret retrieval requests, automating secret rotation, monitoring access events, and/or the like. In some cases, a plugin may be used to perform the functionality described in association with the secrets manager. For instance, a plugin may be installed in association with an existing secrets manager to perform the various functionality described herein (e.g., data management, policy management, rotation management, access management, and secret generation management).

To effectively manage secrets (e.g., policy, rotation, access, and secret generation management), the secrets manager may enable or prepare data associated with secrets to be used to perform various management functions. In this way, data may be processed in a suitable manner for effective secrets management. In particular, and as described herein, the secrets manager may manage data associated with policies and secrets.

In some cases, policies to enforce in association with secrets may be generated or obtained. A policy generally relates to management of secrets, such as how secrets are to be stored, accessed, rotated, generated and/or otherwise managed (e.g., within an organization). In this way, a policy may represent a rule(s) or best practice(s) that ensures desired security and/or compliance, while being structured or machine-readable for performing automated secrets management. To generate a policy, a human-readable policy(ies) may be obtained. In accordance with obtaining a human-readable policy, the obtained policy may be converted into a structured format that can be processed programmatically. In this regard, the policy is codified into a machine-readable format. Various types of formats may be used to represent policies in machine-readable formats. For example, JSON, YAML, and Simple Data Structures may be used to represent policies. In some cases, a configuration file (e.g., formatted in JSON or YAML) may act as a centralized repository for policy definitions. As the configuration file may define policy parameters in a structured, machine-readable format, new policies may be seamlessly incorporated without requiring code changes. Such an approach significantly enhances scalability and adaptability. As new security threats emerge or compliance regulations evolve, organizations can quickly implement new policies without disrupting existing secrets management workflows. By decoupling policy enforcement from the system's core logic, dynamic policy configuration ensures that security controls can continuously evolve in alignment with organizational and regulatory requirements.

In addition to codifying policies, policy tags may be generated in association with the policies. A policy tag generally refers to a tag or identifier indicating a category or type of policy. In this way, a tagging system may be used to help categorize policies, for example, based on secrets managers, infrastructure, infrastructure components, etc. For example, a secrets manager tag may indicate a secrets manager, such as “AWS_Secrets_Manager,” “HashiCorp_Vault,” or “Jenkins.” Tagging policies may ensure that different policies are applied when relevant. For example, a policy may only apply to Jenkins-stored secrets but not AWS secrets.

In preparing data, the secrets manager may also identify metadata for secrets, also referred to herein as secret metadata. Secret metadata generally refers to data or contextual information about a secret. Secret metadata may facilitate organizing, managing, and/or securing secrets. Examples of secret metadata include a secret name, a generation date, an expiration data, an owner, an access permission, a modification history, a usage statistic, a secret type, an associated service(s), whether the secret is to be used for an application(s) or human user(s), a secrets issuer, a secrets manager, etc. In accordance with embodiments described herein, secret metadata may be identified in a manner that preserves confidentiality of the corresponding secret. In this way, secret metadata may be identified without accessing the actual secrets values. Further, metadata scanning and analysis may occur natively, leveraging existing system permissions while avoiding the security risks of external tools. Deriving and tracking metadata dynamically allows for seamless enforcement of policies, automated rotation, and improved auditing capabilities.

In accordance with identifying secret metadata, such metadata may be organized to enable efficient management, retrieval, and enforcement of security policies. For example, secret metadata may be organized into multiple levels, such as secret entries, secret paths, secret folder, and namespaces. The various levels of organization may enable effective categorizing and managing secrets, ensuring that access controls, policies, and automation mechanisms can be applied effectively.

In addition, tags, or secret tags, may be identified for secrets based on the metadata. In this way, secrets may be tagged or associated with tags indicating metadata associated with the secret. In embodiments, to identify or generate secret tags using the metadata, various metadata attributes or values may be dynamically mapped with tags. In some cases, the secret tags may be preconfigured or predefined. For example, secret tags may be preconfigured for TTL, AWS Secrets, tokens, etc. Using predefined tags may facilitate management of secrets in an automated manner. For example, identifying secret tags for metadata associated with secrets may ensure that policies governing secrets management are applied automatically, eliminating the need for custom policy enforcement on a per-secret basis. Implementing such a tag-based system enables automation and scalability of secrets management. For example, in cases in which a secret is tagged with a TTL-30D label, the system can automatically schedule its rotation and renewal, ensuring it does not expire unexpectedly. Advantageously, as new secrets, environments, managers, etc. are introduced, corresponding identified metadata can be used to dynamically assign tags to the secret(s), thereby ensuring that security policies are consistently applied without requiring human intervention. Further, by leveraging metadata-driven tagging of secrets, organizations can enforce security best practices, automate remediation, and enhance overall system reliability, while minimizing manual effort.

Upon preparing or processing data, such data may be used to facilitate management of secrets. In this regard, the secrets manager may perform various functionalities to manage secrets. As one example, the secrets manager may manage policies. In this way, various policies associated with secrets management may be enforced. To manage or enforce policies in association with secrets, the secret metadata and/or secret tags associated with a secret may be used to determine adherence to a relevant policy(ies). In some cases, the secret metadata and/or secret tags may be tokenized. In this way, the previously captured metadata may be segmented into distinct pieces based on the secret tags and used to determine whether data associated with a secret matches a predefined policy associated with a secret. For example, in cases in which a secret has a tag AWS_SECRET, one or more policies associated with AWS secrets (e.g., “Secrets must be stored under/aws/paths”) will be applied. As such, it may be determined whether the secret complies with the policies defined for the secret or corresponding tags. For instance, in cases in which the secret has the tag TTL_90_DAYS, but its actual expiration date is more than 90 days in the future, a policy violation is triggered.

Additionally, the secrets manager may manage rotation of secrets. In particular, the rotation of secrets may be automated within the secrets management system to ensure that secrets do not expire unexpectedly, thereby reducing the risk of security vulnerabilities. Generally, a secret has a predefined Time-To-Live (TTL), which dictates how long the secret remains valid before it must be replaced. For instance, GitLab secrets may have a TTL of 90 days, while Jenkins secrets may have a TTL of 30 days. Such TTL values may be monitored and, when needed, the secrets may be proactively rotated before expiration, ensuring continued secure access without manual intervention. To avoid rotations too near the expiration that could result in service disruptions, a rotation threshold may be used to indicate or define how early a secret should be rotated before it reaches its expiration time, thereby ensuring that users have time to update their systems with the new secret before the old one is invalidated. Automatically rotating secrets may ensure that secrets are consistently refreshed without human intervention, thereby maintaining security compliance and minimizing the risk of expired or compromised secrets affecting system operations.

The secrets manager may also manage access to secrets. In this regard, security measures may be enforced by determining which users are authorized to access specific secrets, thereby preventing unauthorized access to sensitive secrets, enhancing security, and allowing for fine-grained access control at a user or group level. Security is enhanced by preventing unauthorized access, while also simplifying the management of permissions through automated access control mechanisms. Instead of granting access to all team members or those on a distribution list, the secrets manager allows for fine-grained control, ensuring that users only have access to the secrets necessary, for example, in association with their roles, thereby strengthening security and reducing the risk of exposure. In this way, access requests to secrets may be analyzed in real-time and either granted or denied based on stored policies. As such, an access request may be processed directly by the security manager, ensuring immediate enforcement of access rules. In other embodiments, access control decision-making (e.g., allow or deny access to the secrets) from may be performed separate from enforcement. For example, the secrets manager may evaluate access requests and provide an authorization decision (e.g., allow or deny), but the actual enforcement is handled by an external security module.

To perform access control, a requestor of access to a secret(s) may be identified. Based on identifying the accessing requesting user, it may be determined whether the requesting user has access to the particular secret. In this way, a policy indicating access, also referred to herein as an access policy, may be referenced and used to determine whether the user has access to the particular secret. An access policy may indicate or define various access control rules, such as roles or users authorized to view, modify, access, use, or manage a secret. An access policy may include allowed roles (e.g., specific roles that can access a secret), allowed users (e.g., specific user accounts permitted to access the secret), access levels, what actions a role or use can perform, such as read, write, delete, etc.), conditions (e.g., additional constraints such as IP restrictions, time-based access, etc.), and/or the like. In some cases, accesses and/or access attempts may be audited. Various types of data may be captured or recorded, such as user identity, time of request, access decision (e.g., granted or denied), conditions checked, etc. Such logs may be stored for various types of security monitoring.

Further, the secrets manager may facilitate generation or creation of secrets in an automated manner. In this regard, users may interact directly with the secrets management system, which then triggers the creation of new secrets dynamically. In contrast, in conventional implementations, obtaining a secret generally includes interacting with a third-party service responsible for secret generation, onboarding with that service, and manually retrieving the generated secret. Such a conventional implementation is inefficient, involves multiple steps, and is prone to human error, such as neglecting to store or update the secret. In one implementation, a standardized API endpoint may be exposed and serve as a request trigger for secret generation. Accordingly, when a secret generation request is made to this endpoint, the secrets manager may identify a corresponding secret type, such as a GitLab secret, and automatically interact with a predefined secret generation service. Such an implementation ensures that secrets are up to date and eliminates the need for users to manually fetch and manage secrets.

Advantageously, managing secrets in an automated and secure manner facilitates a more robust and effective secrets management system. Further, built-in monitoring (e.g., via a plugin solution in associations with a secrets manager) within the secrets management system itself limits external services accessing the services and enhances governance, security, and reliability. In addition to improved security and monitoring of secrets, computing resource utilization is reduced as less resources may manage secrets in an automated manner. For example, automated policy enforcement, monitoring, and rotation remove the need for frequent manual checks, thereby reducing CPU cycles and database queries. Further, instead of repeatedly querying or storing secrets in an inefficient way, secrets are only rotated when needed based on TTL and pre-configured thresholds, thereby reducing unnecessary computation involved in continuous polling or excessive secret generation. As another example, a plugin-based approach allows for caching metadata to reduce redundant database queries, thereby reducing the frequency of fetching secrets and read operations as well as lowering overall system load. As yet another example, enforcing role-based access control prevents unnecessary secret lookups and unauthorized access attempts, which would otherwise consume processing power.

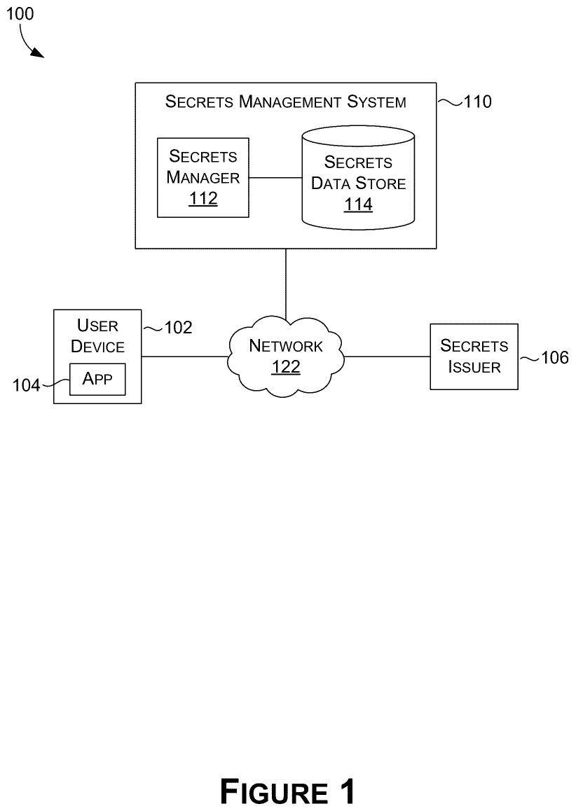

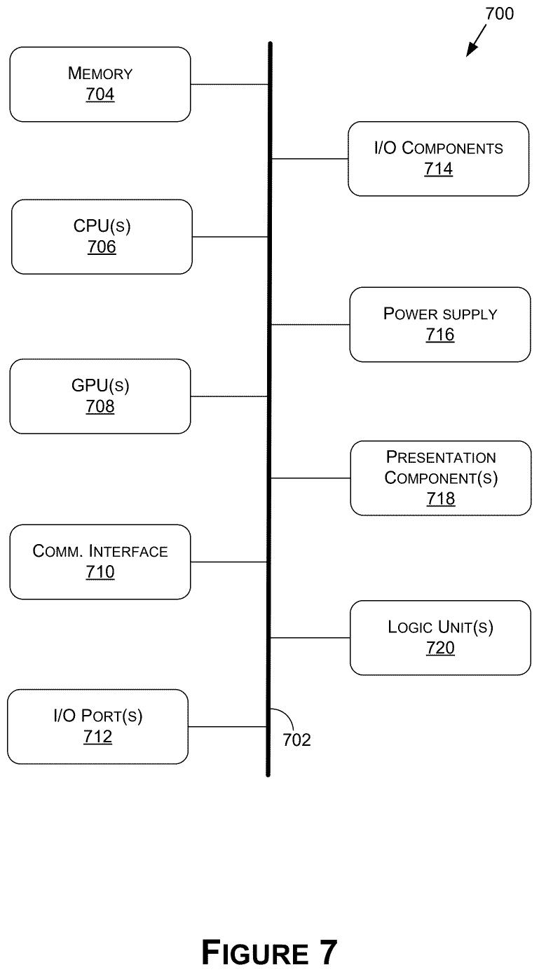

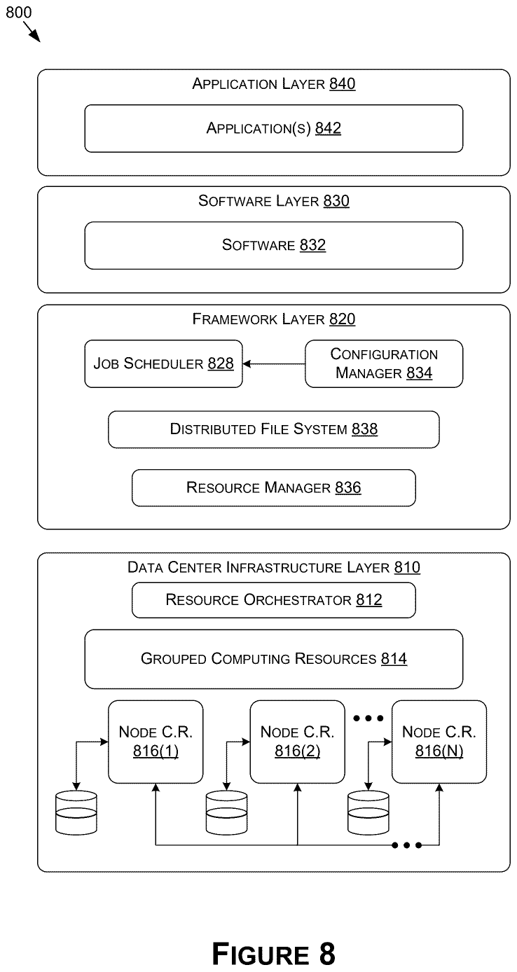

With reference to FIG. 1, FIG. 1 is an example network environment, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented one or more computing devices or components thereof (e.g., as described in FIG. 7), and/or one or more data centers or components thereof (e.g., as described in FIG. 8).

With continued reference to FIG. 1, a block diagram of an exemplary network environment 100 suitable for use in implementing embodiments described herein is shown. Generally, the system 100 illustrates an environment suitable for facilitating management of secrets. Among other things, embodiments described herein effectively and efficiently manage secrets in an automated manner. In particular, such an environment is used to perform data management, policy management, rotation management, access management, and/or secret generation management to facilitate an effective and secure management of secrets.

The network environment 100 includes a user device 102, a secrets issuer 106, and a secrets management system 110. The user device 102, the secrets issuer 106, and the secrets management system 110, can communicate through a network 122, which may include any number of networks such as, for example, a local area network (LAN), a wide area network (WAN), the Internet, a cellular network, a peer-to-peer (P2P) network, a mobile network, or a combination of networks.

The network environment 100 shown in FIG. 1 is an example of one suitable network environment and is not intended to suggest any limitation as to the scope of use or functionality of embodiments disclosed throughout this document, and nor should the exemplary network environment 100 be interpreted as having any dependency or requirement related to any single component or combination of components illustrated therein. For example, the user device may be in communication with the secrets issuer 106 via a mobile network or the Internet, and the user device 102 may be in communication with secrets management system 110 via a local area network. Further, although the environment 100 is illustrated with a network, one or more of the components may directly communicate with one another, for example, via HDMI (high-definition multimedia interface) and DVI (digital visual interface). Alternatively, one or more components may be integrated with one another. For example, at least a portion of the secrets management system 110 may be integrated with the user device 102.

The user device 102 can be any kind of computing device capable of facilitating efficient and effective management of secrets. For example, in an embodiment, the user device 102 can be a computing device such as computing device 700, as described above with reference to FIG. 7. In embodiments, the user device 102 can be a personal computer (PC), a laptop computer, a workstation, a mobile computing device, a personal digital assistant (PDA), a cell phone, or the like.

The user device 102 may include one or more processors and one or more computer-readable media. The computer-readable media may include computer-readable instructions executable by the one or more processors. The instructions may be embodied by one or more applications, such as application 104 shown in FIG. 1. The application(s) may generally be any application capable of facilitating efficient and effective management of secrets. In some cases, the application(s), such as application 104, may facilitate automated management of secrets. In some implementations, the application(s) comprises a web application, which can run in a web browser, and could be hosted at least partially server-side. In addition, or instead, the application(s) may comprise a dedicated application. In some cases, the application is integrated into the operating system (e.g., as a service). Application 104 may be accessed via a mobile application, a web application, or the like.

User device 102 may be a client device on a client-side of operating environment 100, while secrets issuer 106 and/or secrets management system 110 may be on a server-side of operating environment 100. Secrets management system 110 may comprise server-side software designed to work in conjunction with client-side software on user device 110 so as to implement any combination of the features and functionalities discussed in the present disclosure. An example of such client-side software is application 104 on user device 102. This division of operating environment 100 is provided to illustrate one example of a suitable environment, and it is noted there is no requirement for each implementation that any combination of user device 110, secrets issuer 106, and/or secrets management system 110 to remain as separate entities.

In an embodiment, the user device 110 is separate and distinct from the secrets issuer 106 and the secrets management system 110 illustrated in FIG. 1. In another embodiment, the user device 102 is integrated with one or more illustrated components. For instance, the user device 102 may incorporate functionality described in relation to the secrets management system 110. For clarity of explanation, embodiments are described herein in which the user device 102, the secrets issuer 106, and the secrets management system 110 are separate, while understanding that this may not be the case in various configurations contemplated.

As described, a user device, such as user device 102, may facilitate automated management of secrets. A user device 102, as described herein, may be operated by an individual or set of individuals that desire to use a secret. In this regard, a user device 102 may request and use secrets, while interacting with both the secrets issuer 106 and/or the secrets management system 110. In operation, the user device 102, such as a laptop, mobile phone, server, or IoT device, may need to access to a secured resource, such as an API, database, or cloud service. To obtain the necessary credentials, the user device 102 may authenticates itself to the security issuer 106 (e.g., an identity provider, certificate authority, or cloud service). Authentication may include multi-factor authentication (MFA), OAuth-based token exchanges, certificate validation, or federated identity verification using protocols, such as SAML or OpenID Connect. Upon a successful authentication, the secrets issuer 106 may generate or assign a secret, such as an API key, JWT token, or encryption key, and securely delivers it to the user device 102 through an encrypted channel.

In accordance with receiving the secret at the user device 102, the user device 102 may use the secret. In embodiments, the user device 102 may initiate storage of the secret. In particular, in some cases, the user device 102 may initiate storage of the secret via the secrets management system 110, for example, for secure storage retrieval, and rotation of secrets, etc. For example, the user device 102 may interact with the secrets management system 110 to request secrets dynamically when needed. Upon receiving a request, the secrets manager 112 of the secrets management system 110 may verify the user device's authentication and authorization, retrieve the secret from the secrets data store 112, decrypts it in memory, and delivers it to the user device 102. Accordingly, the secrets remain centrally managed and protected, minimizing risks associated with static credentials stored directly on the device.

In addition, the user device 102 may communicate with the secrets management system 110 in relation to management of secrets. For example, the secrets management system may notify the user device 102 when a secret has been rotated. In some cases, the user device 102 may request the latest version based on the notification. User device interactions with the secrets management system may be logged and monitored for auditing, compliance, and security. By integrating with a secrets management system 110 (rather than handling secrets independently), the user device 102 benefits from centralized security policies, automated secret lifecycle management, and enhanced protection against credential leaks and/or unauthorized access.

The secrets issuer 106 generally generates and provisions secrets, such as API keys, encryption keys, authentication tokens, or credentials. As described, such secrets may be stored and managed within secrets management system 110. The secrets issuer 106 may be, for example, a cloud service provider, an internal identity management system, a certificate authority, a custom enterprise authentication service, or the like. As described, when a user device (such as a laptop, mobile phone, or server) requests access to a secured resource, it generally obtains a valid secret from the secrets issuer 106. The device typically authenticates itself through multi-factor authentication, certificates, or federated identity protocols (e.g., OAuth, SAML, or OpenID Connect). Once verified, the secrets issuer 106 generates or assigns a secret to the user device 102 and securely transmits it, often through an encrypted channel. Although a single secrets issuer 106 is illustrated, any number of secrets issuers may be used. For example, the user device (e.g., via app 104) may request a first secret from a first secrets issuer and a second secret from a second secrets issuer.

The secrets management system 110 is generally configured to securely manage and store secrets. In this regard, the secrets management system 110 may manage data, policies, access, rotation, creation, etc. of secrets. As described, when the user device 102 needs to use a secret (e.g., to access an API or decrypt sensitive data), it queries the secrets manager, which validates the request, retrieves the encrypted secret from the secrets data store, and securely delivers it to the device. Using the secrets management system, as described herein, enables secrets to remain secure, centrally managed, and accessible only to authorized devices and users while minimizing the risk of exposure or compromise.

A secrets management system 110 may include various components, including a secrets manager 112 and a secrets data store 114. At a high level, the secrets management system 110 ensures that authorized users, applications, or services can retrieve secrets, while maintaining audit logs, automatic rotations, access enforcement, etc. to prevent unauthorized access and credential leaks. In embodiments, when a request for a secret is made, the secrets manager 112 may verify the requester's identity and permissions, retrieve a desired secret from the secrets data store 114, decrypts it, and securely delivers it to the requester. In some cases, the secrets management system may integrate with cloud services, DevOps pipelines, and/or container orchestration tools. Examples of secrets management systems include HashiCorp® Vault, AWS® Secrets Manager, Azure® Key Vault, and Google® Cloud Secret Manager, each offering different storage backends, access control mechanisms, and integrations. By implementing a robust secrets management system, organizations can reduce security risks, enforce least privilege access, and automate the lifecycle of credentials, ensuring that sensitive information remains protected against unauthorized access and breaches.

The secrets manager 112 may be configured to orchestrate the secure storage, access, and lifecycle management of secrets, such as API keys, database passwords, encryption keys, and authentication tokens. As a central control layer, a secrets manager 112 provides policy enforcement, authentication, authorization, auditing, secret rotation, secret generation, etc. ensuring that only authorized users, applications, or services can access secrets when needed. It may not store secrets directly but interacts with a secrets data store 114, such as an encrypted secrets data store, where the actual secrets are securely persisted. In embodiments, the secrets manager 112 may facilitate role-based access control or identity-based access control, thereby ensuring that access to secrets is limited based on predefined security policies.

When an application or user requests access to a secret, the secrets manager 112 may authenticate the requester using credentials such as API tokens, OAuth identities, or cloud IAM roles. Once authenticated, the secrets manager 112 may check the access control policies to determine whether the requester has the necessary permissions to retrieve the secret. If access is granted, the secrets manager 112 retrieves the encrypted secret from the secrets data store 114, decrypts it in memory, and securely delivers it to the requesting application.

Additionally, the secrets manager 112 supports automatic secret rotation, which updates secrets at scheduled intervals or upon certain triggers (e.g., key expiration, security incidents, etc.). For example, if a database password is rotated, the secrets manager 112 updates the secrets data store 114, synchronizes the change with the database, and notifies authorized services (e.g., to initiate retrieval of the new version of the secret). In some cases, the secrets manager 112 may log access attempts, changes, and retrievals to maintain a detailed audit trail, ensuring compliance with security policies and regulatory requirements.

Examples of secrets managers include AWS® Secrets Manager, HashiCorp® Vault, Azure Key Vault®, and Google® Cloud Secret Manager, each providing various integrations with cloud services, Kubernetes, and DevOps pipelines. By acting as a mediator between applications and the secrets data store 114, a secrets manager helps organizations maintain centralized control, security, and automation over their sensitive secrets, preventing unauthorized access and reducing the risk of credential leaks.

In some cases, the functionality described herein, such as data management, policy management, rotation management, access management, and/or secret generation may be included directly in functionality provided by a secrets manager 112. In other cases, such functionality may be added to a secrets manager 112, for example, via a plugin. In this way, a plugin may be installed in association with a secrets manager to perform various secrets management functionality described herein. In some cases, a plugin may correspond with a particular type of secrets. In this regard, a particular plugin may be used for a particular type of secrets (e.g., Jenkins secrets). Accordingly, any number of plugins may be installed in association with a secrets manager 112.

In embodiments, the secrets manager 112 may manage any type of secrets. In this regard, assume a secrets manager 112 corresponds with a particular type of secrets (e.g., AWS secrets). In such a case, the secrets manager 112 may manage various types of secrets, in addition to the AWS secrets.

The secrets data store 114 generally refers to a secure backend storage component within the secrets management system 110. The secrets data store 114 may be responsible for persistently storing and encrypting sensitive credentials, such as API keys, database passwords, encryption keys, and authentication tokens. In embodiments, the secrets data store 114 is dedicated to protecting secrets, ensuring that they remain protected from unauthorized access or exposure. Secrets within the data store may be encrypted using strong cryptographic algorithms (such as AES-256) and may be further secured through Hardware Security Modules (HSMs), cloud-based Key Management Systems (KMS), or specialized storage backends like Consul, relational databases, object storage, or distributed key-value stores.

In embodiments, the secrets data store 112 may store additional data. For example, the secrets data store 112 may store secret metadata, audit logs, etc. For example, when a credential needs to be updated (e.g., database password rotation), the secrets manager 112 may store audit logs of changes, accesses, and rotations, providing a history of how secrets have evolved over time.

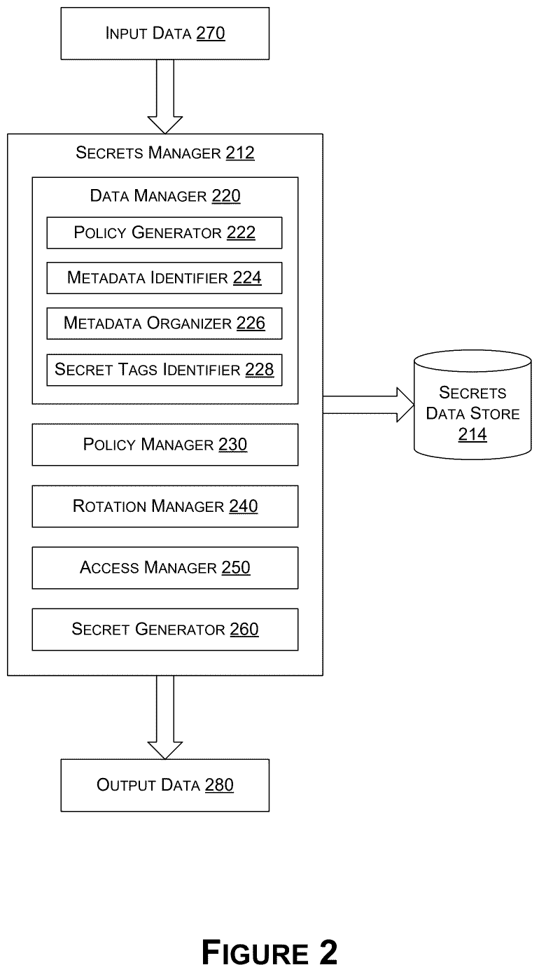

Turning now to FIG. 2, FIG. 2 illustrates an example implementation for facilitating effective management of secrets via secrets manager 212. In operation, the secrets manager 212 is generally configured to manage secrets stored in a secrets data store 214. In particular, secrets manager 212 may manage data, policy enforcement, rotations, access, and secret generation. Advantageously, and in accordance with embodiments described herein, performing automated secrets management in an efficient and effective manner can result in timely secrets management and enhance security associated with secrets.

The secrets manager 212 may communicate with the secrets data store 214. The secrets data store 214 is configured to store secrets accessible by the secrets manager 212, or another server or component. In embodiments, secrets manager 212, user device(s) (such as user device 102 of FIG. 1), and/or secrets issuer 106 of FIG. 1 can provide data to the secrets data store 214 for storage, which may be retrieved or referenced by any such component. As such, the secrets data store 214 may store various types of secrets, such as database credentials, authentication tokens, API keys, certificates, and/or the like. The secrets data store 214 may persist secrets in a secure and encrypted manner. In embodiments, the secrets manager 212 and the secrets data store 214 may be part of a secrets management system (e.g., secrets management system 110).

As shown, in embodiments, input data 270 may be provided to the secrets manager 212. Various types of input data 270 may be input and may be input at various times. By way of example only, user or system authentication data (e.g., in association with a user or application requesting access), secret storage requests, policies (e.g., access policies), secret rotation configurations (e.g., frequency of rotating secrets), and/or the like may be provided as input data 270 to the secrets manager 212 for use by the secrets manager 212. The secrets manager 212 may obtain various types of input data 270 and manage secrets in accordance therewith.

The secrets manager 212 may generally manage secrets in association with the secrets data store 214. The secrets manager 212 generally includes a control and access layer. A secrets manager may be responsible for managing access, handling secret retrieval requests, automating secret rotation, monitoring access events. In some cases, a plugin may be used to perform the functionality described in association with the secrets manager 212. By way of example, assume a secrets manager 212 is implemented. In such a case, a plugin may be installed in association with the secrets manager 212 to perform the various functionality described herein (e.g., data management, policy management, rotation management, access management, and secret generation management).

To effectively and efficiently manage secrets, in some embodiments, the secrets manager 212 includes a data manager 220, a policy manager 230, a rotation manager 240, an access manager 250, and a secret generator 260. According to embodiments described herein, the secrets manager 212 can include any number of other components not illustrated. In some embodiments, one or more of the illustrated components 220, 230, 240, 250, and 260 can be integrated into a single component or can be divided into a number of different components. Components 220, 230, 240, 250, and 260 can be implemented on any number of machines and can be integrated, as desired, with any number of other functionalities or services.

The data manager 220 is generally configured to manage data associated with secrets management. In this way, to effectively manage secrets, the data manager 220 may process data in a manner in which the data may be used for effective secrets management. In particular, and as described herein, the data manager 220 may manage data associated with policies and secrets. The data manager 220 may include various components to manage data. In one embodiment, the data manager 220 includes a policy generator 222, a metadata identifier 224, a metadata organizer 226, and a secret tags identifier 228. Although the functionality is described in association with components 222, 224, 226, and 228, any number of components may be implemented to perform the functionalities described herein.

The policy generator 222 is generally configured to generate or obtain policies that may be enforced in association with secrets. A policy generally relates to management of secrets, such as how secrets are to be stored, accessed, rotated, generated and/or otherwise managed (e.g., within an organization). In this way, a policy may represent a rule(s) or best practice(s) that ensures desired security and/or compliance, while being structured or machine-readable for performing automated secrets management.

To generate a policy, the policy generator 222 may obtain a human-readable policy(ies). A human-readable policy generally refers to a policy that defines secrets management rule in a format that humans can understand. In this way, an individual (e.g., a Chief Intelligence Officer, etc.) or team of individuals may prepare a human-readable policy. Such human-readable policies may include indications of what may and may not be performed in association with secrets. Examples of human-readable policies include “All secrets must be rotated every 30 days,” “Secrets must never be hardcoded in source code repositories,” and “Access to production secrets requires multi-factor authentication.”

In accordance with obtaining a human-readable policy, the policy generator 222 may convert the human-readable policy into a structured format that can be processed programmatically. In this regard, the policy is codified into a machine-readable format. Various types of formats may be used to represent policies in machine-readable formats. For example, JSON, YAML, and Simple Data Structures may be used to represent policies. One example policy in machine-readable format may be represented as:
{
“policy_name”: “Rotate API Keys”,
“description”: “API keys must be rotated every 30 days.”,
“enforcement”: “mandatory”, “scope”: [“AWS Secrets Manager”],
“ttl”: “30d”
}

The policy generator 222 may enable dynamic policy configuration. Dynamic policy configuration may ensure that policies (e.g., security policies) governing secrets management may evolve without requiring modifications to the underlying secrets manager 212, or portion thereof. In this regard, the policy generator 222 may allow for new policies to be added or existing policies to be adjusted without redeploying the system or requiring development effort. In this way, a configuration file (e.g., formatted in JSON or YAML) may act as a centralized repository for policy definitions. As the configuration file may define policy parameters in a structured, machine-readable format, the secrets manager 212 may seamlessly incorporate new policies without requiring code changes. For example, assume 50 security-approved policies exist that govern secret storage, expiration, and distribution. Further assume, the number of policies increases to 100. In such a case, the configuration file may be updated without redeploying the secrets manager, or portion thereof.

This approach significantly enhances scalability and adaptability. As new security threats emerge or compliance regulations evolve, organizations can quickly implement new policies without disrupting existing secrets management workflows. The rule engine within the plugin dynamically interprets the updated policies, ensuring enforcement remains current and comprehensive. By decoupling policy enforcement from the system's core logic, dynamic policy configuration ensures that security controls can continuously evolve in alignment with organizational and regulatory requirements.

In addition to codifying policies, the policy generator 222 may facilitate identifying or generating tags for policies, also referred to as policy tags. A policy tag generally refers to a tag or identifier indicating a category or type of policy. In this way, a tagging system may be used to help categorize policies, for example, based on secrets managers, infrastructure, infrastructure components, etc. For example, a secrets manager tag may indicate a secrets manager, such as “AWS_Secrets_Manager,” “HashiCorp_Vault,” or “Jenkins.” For instance, some policies may be applicable for Jenkins-provided secrets only and, as such, be tagged with a secrets provider of Jenkins. An infrastructure tag may refer to secrets related to particular infrastructure, such as an AWS infrastructure, Azure services, etc. An infrastructure component tag may refer to secrets related to a type of infrastructure component, such as secrets for database access, secrets for network, secrets for Kubernetes clusters, secrets for Continuous Integration and Continuous Deployment (CI/CD) tools (e.g., Jenkins, GitHub actions), secrets for serverless applications (e.g., AWS Lambda), etc.

Tagging policies may ensure that different policies are applied when relevant. For example, a policy may only apply to Jenkins-stored secrets but not AWS secrets. Further, policy tagging enables a scalable and dynamic approach. For instance, if a new secrets manager emerges in the future, the framework can adapt dynamically by adding new a policy tag or modifying a policy tag to account for the new secrets managers.

The metadata identifier 224 is generally configured to identify metadata for secrets, also referred to herein as secret metadata. Secret metadata generally refers to data or contextual information about a secret. In this way, secret metadata generally refers to structured information that describes or provides context to secrets stored in a secrets data store. Secret metadata may facilitate organizing, managing, and/or securing secrets. Examples of secret metadata includes a secret name (e.g., identifier of a secret), a generation date (e.g., a date secret was generated), an expiration data (e.g., a TTL value indicating when the secret will expire or need rotation), an owner (e.g., individual or team responsible for secret), an access permission (e.g., information about who can view, edit, or delete a secret), a modification history (e.g., a log of changes made to the secret, including who made the changes and when), a usage statistic (e.g., data on how often and by whom the secret is accessed), a secret type (e.g., type of secret such as a password, API key, certificate, or token), an associated service(s) (e.g., services or applications that use the secret), whether the secret is to be used for an application(s) or human user(s), a secrets issuer, a secrets manager, etc.

In accordance with embodiments described herein, secret metadata may be identified in a manner that preserves confidentiality of the corresponding secret. In particular, the metadata identifier 224 may identify secret metadata without accessing the actual secrets values. As described, within a secrets data store, sensitive values such as API keys, database credentials, and SSH keys are stored. Without directly interacting with these values, the metadata identifier 224 can identify or extract metadata to determine key attributes such as the secret's issuer, manager (e.g., AWS® Secrets Manager, HashiCorp® Vault), intended use (e.g., for applications or human users), lifecycle policy (e.g., rotation frequency), etc.

Advantageously, the metadata identifier 224 is integrated directly with the secrets management system. In this way, metadata scanning and analysis occur natively, leveraging existing system permissions while avoiding the security risks of external tools. By structuring metadata collection in this way, policies may be enforced without exposing the secret's actual value. The built-in metadata identifier 224 may scan stored secrets and identify various secret metadata, such as ownership, role of owner, generation data, expiration data, rotation data (e.g., dates, status, etc.), indication of manual or automatically generated secret, etc. For example, assume a token is stored as a secret in a secrets data store 214. In such a case, secret metadata may be identified that indicates who created the token, the entity it was intended for, function of the token, and its lifecycle status.

Secret metadata identification may occur at various times. In some cases, secret metadata may be identified in association with generating secrets. In particular, in creating a secret, secret metadata may also be created. In some cases, static metadata that does not change over time, such as the source of the secret, its intended use, and/or associated endpoints, may be identified. For example, assume a GitLab access token is generated and stored in the secrets management system. In such a case, secret metadata indicating that it was obtained from gitlab.com/nvidia.gitlab.com/poweredup and is intended for CI/CD pipeline authentication may be identified.

Additionally or alternatively, dynamic metadata values that may change over time may be identified. In this regard, as dynamic metadata values are generated or changed, the metadata identifier 224 may identify such secret metadata. In some cases, using static metadata (e.g., secrets manager and endpoint) and dynamic metadata (such as last rotation date) enables a more structured and automated approach to managing secrets. In embodiments, such metadata may be maintained in association with the secret, making it easier to track and manage without needing to retrieve the actual sensitive data.

By structuring metadata identification or collection as described, secrets management becomes more secure, scalable, and efficient. Deriving and tracking metadata dynamically allows for seamless enforcement of policies, automated rotation, and improved auditing capabilities.

The metadata organizer 226 is generally configured to organize secret metadata. Performing secret metadata organization enables efficient management, retrieval, and enforcement of security policies. In this regard, the metadata organizer 226 may organize the secret metadata into multiple levels, such as secret entries, secret paths, secret folder, and namespaces. The various levels of organization may enable effective categorizing and managing secrets, ensuring that access controls, policies, and automation mechanisms can be applied effectively.

At a most granular level, a secret entry generally refers to a single secret or sensitive credential, such as an API key, database password, or SSH key. As such, a single entry includes the actual sensitive data. In some embodiments, a secret entry includes a secret name, a secret value, and corresponding secret metadata. In this way, each secret entry includes the secret and associated metadata, such as the secrets manager, secrets issuer, purpose, creator, rotation policy, and expiration date.

Accordingly, in embodiments, secrets may be associated with the corresponding metadata in the secret entry. In this way, upon identifying various secret metadata associated with a secret, the secret may be associated with such secret metadata. In some cases, the secret metadata associated with the secret may be stored in the secrets data store, such as secrets data store 214. For example, instead of only storing an API key in the secrets data store, the data store may also store relevant metadata, for instance as key-value pairs. By way of example only, a secret entry may be represented as follows:
Secret Name: gitlab-token
Secret Value: SecretValue123
Metadata:
   provider: GitLab
   owner: DevOps Team
   rotation: 30 days
   last_rotated: Jan. 15, 2024
   usage: CI/CD pipeline

As such, organizing metadata as secret entries enables the storing of secret metadata in association with the secret to allow for structured tracking, management, and automation of secrets without needing to access or expose the actual secret value. Organizing secrets at this level ensures that every credential is properly tagged, making it easier to enforce security measures such as automated rotation and expiration alerts. In embodiments, the metadata may be used to categorize secrets within secret paths, folders, and/or namespaces.

A secret path generally refers to a logical location where a secret(s) is stored, for example, with a secrets data store. A secret path helps structure secrets in a meaningful way, often reflecting their usage or origin. For example, a GitLab token might be stored under the path/git-tokens/project-x, while a database password might be located at/database/secrets/prod. Paths enable hierarchical organization, making it easier to manage related secrets collectively. A secret path also facilitates structured access control, where permissions may be granted at different levels of the hierarchy, such as role-based access control (RBAC). For example, a database administrator may have access to secrets/app1/database/but not secrets/app2/api.

A secret folder is a higher-level grouping of related secrets, often representing a service, application, or department. For example, a folder named “/database/secrets/” might include multiple secrets related to different database instances, while a folder named “/ci-cd/tokens/” might store access tokens for various CI/CD pipelines. Organizing secrets into folders ensures that related credentials can be managed as a group or unit, thereby simplifying audits, access management, and policy enforcement. Secret folders may also be used to enforce role-based access.

At the highest level, a namespace may provide an isolated environment within the secrets data store to organize and manage stored data, generally allowing for multi-tenancy and broader segmentation. A namespace generally refers to a logical container that groups related data. In this way, namespaces can be used to separate secrets based on business units, environments (e.g., development, staging, production), applications, organizations, etc. For example, separate namespaces may be created for different cloud providers (/aws, /azure, /gcp), different teams within an enterprise (/finance, /engineering, /marketing), and/or the like. Using namespaces may ensure that secrets remain isolated and that policies can be applied at a broad level, governing multiple secrets and folders within a namespace.

By structuring metadata at different levels, such as secret entities, paths, folders, and/or namespaces, the system enables better access control, policy enforcement, and automation. For example, organizing metadata in this way allows rules to be applied dynamically, ensuring that secrets are categorized correctly and that security policies can be tailored to different environments and use cases. This hierarchical structure also enhances scalability, allowing new secrets, services, and/or manager to be integrated seamlessly while maintaining a consistent security framework.

The secret tags identifier 228 is generally configured to identify tags for secrets, also referred to as secret tags, based on the metadata. In this way, secrets may be tagged or associated with tags indicating metadata associated with the secret. In embodiments, the secret tags are stored in the secrets data store. In some cases, the secret tags are stored separate from the actual secret value, thereby allowing for automation, security, and policy enforcement without exposing sensitive data.

In embodiments, to identify or generate secret tags using the metadata, the secret tags identifier 228 may dynamically map various metadata attributes, properties, or values with tags. In some cases, the secret tags may be preconfigured or predefined. For example, secret tags may be preconfigured for TTL, AWS Secrets, tokens, etc. Using predefined tags may facilitate management of secrets in an automated manner. For example, identifying secret tags for metadata associated with secrets may ensure that policies governing secrets management are applied automatically, eliminating the need for custom policy enforcement on a per-secret basis. In particular, by associating metadata attributes with specific tags, the system can categorize secrets and automate their lifecycle management, access controls, and policy enforcement without requiring manual intervention.

As described, dynamic mapping allows classification of secrets based on the corresponding metadata attributes, such as expiration policies, security requirements, source, and intended usage. In this way, secret tags may serve as predefined labels that indicate or define how a secret should be handled. For instance, a tag TTL-30D may indicate that a secret must be rotated every 30 days, and a tag AWS-SECRETS may indicate that the secret originates from AWS Secrets Manager. Other examples of configured tags include TOKEN, which may categorize secrets as authentication credentials, or CI/CD-TOKEN, which designates secrets used in continuous integration and deployment pipelines. Environment-specific tags like DEV, STAGING, and PROD further define where and how a secret should be utilized.

Implementing such a tag-based system enables automation and scalability of secrets management. For example, in cases in which a secret is tagged with a TTL-30D label, the system can automatically schedule its rotation and renewal, ensuring it does not expire unexpectedly. Similarly, if a secret is categorized as a PROD secret, the corresponding secret may be automatically restricted to production environments, preventing accidental exposure in non-production systems. Secret tags also enable dynamic enforcement of security policies, such as, for example, ensuring that database credentials have multi-factor authentication enabled before access is granted.

By way of example only, assume a GitLab access token is stored in a secrets data store, such as secrets data store 214. Further assume that metadata associated with the secret includes the corresponding secrets manager (GitLab), usage (CI/CD Pipeline), expiration (30 days), and environment (production). In such a case, the secret tags identifier 228 may map the metadata to predefined relevant tags, such as GITLAB-TOKEN, CI/CD-TOKEN, TTL-30D, and PROD, respectively, which may then be assigned or designated in association with the secret. With such secret tags applied, the secrets manager 212 can enforce automated secret rotation every 30 days, restrict access to Development and Operations engineers, and trigger alerts if the token is used outside its intended scope.

As another example, assume an AWS database credential (e.g., AWS RDS password) is stored in a secrets data store, such as secrets data store 214. In such a case, based on metadata identified in association with the secret, the secret tags identifier 228 may assign various tags to the secret, such as tags designating AWS-SECRETS, DB-CREDENTIAL, TTL-90D, and STAGING. Based on such tags, the secrets manager 212 can automatically rotate the credential every 90 days, ensure that only the staging application has access, and log all access events for security audits. Such automated processes significantly reduce the risk of secret exposure and ensure compliance with security policies.

The secret tags may be stored in association with the corresponding secrets. In some cases, the secret tags may be stored in the secrets data store 214. Alternatively or additionally, the secret tags and/or secret metadata may be stored in association with the secret managers 212, or portion thereof. For example, in some cases, secret tags and/or secret metadata may be replicated and stored in memory in association with a secrets manager 212 (e.g., in the form of a plugin). In such a case, the actual secrets values may remain in the secrets data store 214 and not replicated to memory.

Advantageously, as new secrets, environments, managers, etc. are introduced, corresponding identified metadata can be used to dynamically assign tags to the secret(s), thereby ensuring that security policies are consistently applied without requiring human intervention. Further, by leveraging metadata-driven tagging of secrets, organizations can enforce security best practices, automate remediation, and enhance overall system reliability, while minimizing manual effort.

The policy manager 230 is generally configured to manage policies, such as policies generated via policy generator 222. In this way, the policy manager 230 may be configured to enforce various policies associated with secrets management. To manage or enforce policies in association with secrets, the policy manager 230 may use the secret metadata and/or secret tags associated with a secret to determine adherence to a relevant policy(ies). In this way, the policy manager 230 may determine whether a secret metadata and/or secret tag associated with a secret matches or adheres to a policy.

In some cases, the policy manager 230 may tokenize the secret metadata and/or secret tags. To do so, the policy manager 230 may perform parsing. In this way, the policy manager 230 may read and parse the metadata associated with each secret. For example, the policy manager 230 may parse the secret's path, expiry date, and owner. As one example, the policy manager 230 may parse previously captured metadata and tokenize along the previously generated or defined secret tags. In this way, the policy manager 230 may break down the previously captured metadata into distinct pieces based on the secret tags. In some cases, such a process may include recognizing structured markers or labels in the secret metadata (e.g., <secret>, <owner>, or key-value pairs). Thereafter, the tagged values may be extracted, for instance, by extracting the data by separating content based on the tags. The parsed metadata can then be separated into tokens, for instance, by separating at tag boundaries to create distinct elements, breaking down values in the tags, etc.

In accordance with identifying secret tags and/or metadata, or a portion thereof, the policy manager 230 may determine whether the data associated with, or assigned to, a secret matches a predefined policy that are associated with those tags. For example, in cases in which a secret has a tag AWS_SECRET, one or more policies associated with AWS secrets (e.g., “Secrets must be stored under/aws/paths”) will be applied. As another example, in cases in which a secret has the tag TTL_90_DAYS, the secret, or metadata or metadata tag associated therewith, may be checked against policies for TTL expiration (e.g., “All secrets must rotate every 90 days”).

In this regard, the policy manager 230 determines or checks if the secret complies with the policies defined for the secrets or secret tags. For example, in cases in which the secret has the tag TTL_90_DAYS, but its actual expiration date is more than 90 days in the future, a policy violation is triggered. As another example, in cases in which a secret is tagged as AWS_SECRET but is stored in an incorrect path per a corresponding policy, the lack of compliance may be flagged as a violation.

Accordingly, such metadata tokenization allows the policy manager 230 to map individual metadata elements (such as expiration dates, access restrictions, or storage locations) directly to policies. For example, if a secret has the tag AWS_SECRET, the tokenization process may extract metadata elements such as:
provider: AWS
usage: API_KEY
expiration: 90_days
storage_path: /secrets/aws/
access_group: DevOps

Such tokens may then be cross-referenced with predefined policies. The policy manager 230 may check, for example, whether all AWS_SECRET tokens are stored in the correct path or whether secret tagged TTL_90_DAYS are actually set to expire in 90 days. As such, policies are actively enforced based on metadata-driven rules rather than just assigning labels to secrets.

In embodiments, to facilitate an efficient analysis of policies, a hash map may be generated and used. Such a hash map may include policies and corresponding secret tags to which they apply. Generally, a hash map may be a data structure (e.g. storing key-value pairs) enabling fast lookups. In this way, the hash map may correlate a policy to enforce when handling secrets associated with corresponding secret tags. As such, a hash map that links each tag to specific policies may ensure that the right compliance checks are performed. For example, assume a secret is tagged as AWS_SECRET. In such a case, it may be validated against policies that dictate where AWS-related secrets should be stored and who can access them. Similarly, a TTL_90_DAYS tag triggers checks to confirm that the secret's expiration period aligns with the policy. Maintaining a hash map, or other similar structure, the system enables dynamic policy enforcement without requiring manual intervention for each individual secret.

In cases in which a policy is not adhered to or a violation(s) is detected, such as an AWS secret being stored outside its designated location or a secret exceeding its allowed TTL, the policy manager 230 may flag the issue and/or trigger remediation actions. For example, the policy manager 230 may present an alert or notice to a user or initiate an action that addresses the policy violation.

The policy manager 230 may verify policies in association with secrets at any time. For example, policy verification may occur at a time a secret is created or modified. As another example, policy verification may occur on a periodic basis (e.g., upon expiration of a predetermined time duration). As another example, policy verification may occur when a secret is accessed, requested, rotated, stored, deleted, etc. For example, in accordance with an attempt to access a secret, the policy manager 230 may use tags associated with the secret to determine which policies to apply or verify.

Such a policy manager 230 allows for automated validation, where the policy manager 230 scans secrets for policy violations and triggers necessary remediation actions if discrepancies are found. As the hash map is structured for quick lookups, performance and scalability is enhanced, thereby enabling efficient enforcement of policies across a large number of secrets. Further, as new secrets are introduced or policy requirements evolve, enforcement remains consistent and adaptable without requiring extensive reconfiguration.

The policy manager 230 may provide output data 280 in association with the policy management. For example, the status of access control enforcement (e.g., allowed or denied) may be provided, for example, to a data store or to an access requestor.

The rotation manager 240 is generally configured to manage rotations in association with secrets. In particular, the rotation manager 240 may automate the rotation of secrets within the secrets management system to ensure that secrets do not expire unexpectedly, thereby reducing the risk of security vulnerabilities. Generally, a secret has a predefined Time-To-Live (TTL), which dictates how long the secret remains valid before it must be replaced. For instance, GitLab secrets may have a TTL of 90 days, while Jenkins secrets may have a TTL of 30 days. The rotation manager 240 may monitor these TTL values and proactively rotate secrets before they expire, ensuring continued secure access without manual intervention. In some cases, monitoring for proactively rotating secrets may occur in a periodic manner (e.g., upon expiration of a predetermined time duration). In other cases, monitoring to proactively rotate secrets may occur in association with an event, such as a request to access a secret(s), etc.

In some embodiments, to manage rotation of secrets, the rotation manager 240 may iterate through stored secrets and monitor the corresponding creation times. In recognizing when a secret is created and referencing a TTL value for the corresponding secret, a rotation due date for the secret may be determined. For example, an expiration time of a secret may be determined as follows:
EXPIRATION_TIME=CREATION_TIME_OF_SECRET+TTL_OF_SECRET_TYPE

By way of example only, assume a GitLab secret was created on January 1st and has a TTL of 90 days. In such a case, its expiration would be March 31st. Similarly, a Jenkins secret created on January 1st with a TTL of 30 days would expire on January 31st.

To avoid rotations too near the expiration that could result in service disruptions, the rotation manager 240 may use a rotation threshold, also referred to herein as a ROTATION_THRESHOLD_FOR_SECRET. A rotation threshold may indicate or define how early a secret should be rotated before it reaches its expiration time. In this way, a rotation date or time may be determined as follows:
ROTATION_TIME=EXPIRATION_TIME-ROTATION_THRESHOLD_FOR_SECRET
   For instance, assume the rotation threshold for a GitLab secret is set at 10 days. In such a case, instead of waiting until March 31^{st} to perform rotation of a secret, the rotation manager 240 may initiate the rotation process on March 21st. This ensures that users have time to update their systems with the new secret before the old one is invalidated.

During this rotation period, both the original and the newly generated secret may be temporarily valid, providing a buffer period for users or applications to transition smoothly. Once the EXPIRATION_TIME has passed, however, the old secret may be automatically deleted from the secrets management system, and only the newly rotated secret remains active. In embodiments, the values for TTL_OF_SECRET_TYPE and ROTATION_THRESHOLD_FOR_SECRET may be dynamically retrieved from a configuration file or other data structure. In this way, such values may not be hardcoded into the secrets manager, or portion thereof, thereby allowing administrators to modify rotation policies without requiring changes to the secrets manager itself. Automatically rotating secrets may ensure that secrets are consistently refreshed without human intervention, thereby maintaining security compliance and minimizing the risk of expired or compromised secrets affecting system operations.

In some cases, the rotation time may be stored and used as a reference to rotate a secret. For example, in accordance with determining a rotation time of Mar. 21, 2025, the rotation time may be stored and used to initiate a rotation on March 21^{st}. In other cases, the rotation time may be dynamically determined and used to initiate a rotation as needed. For instance, the rotation manager may continuously monitor secret metadata to identify when a secret is approaching a rotation time.

In accordance with an occurrence of the rotation time, the rotation manager 240 may be configured to initiate rotation of the secret to obtain a new secret. For example, the rotation manager 240 may request a new secret, or a new version of the secret, form the appropriate secrets issuer or secrets manager. For instance, in cases a GitLab API token is being rotated, the rotation manager 240 may make a request to GitLab's API to generate a new access token. The newly generated secret may then be stored in the secrets data store. Further, secret metadata may be updated with a new creation and expiration timestamps. In embodiments, the rotation manager 240, or other component, may ensure that applications, scripts, or CI/CD pipelines that use the secret switch to the new secret. For example, the rotation manager 240 may initiate automatic updates, for example, via automatic updates, notifications, manual intervention, etc.

The rotation manager 240 may provide output data 280 in association with the rotation management. For example, the new rotated secret or a rotation status may be provided, for example, to a data store, such as secrets data store 214.

The access manager 250 is generally configured to manage access to secrets. In this regard, the access manager 250 may enforce security measures by determining which users are authorized to access specific secrets, thereby preventing unauthorized access to sensitive secrets, enhancing security posture, and allowing for fine-grained access control at a user or group level. As such, the access manager 250 may achieve this by granting permissions, validating role definitions and/or policies, and ensuring that access is restricted to only those with appropriate access privileges (e.g., based on predefined policies).

The access manager 250 enhances security by preventing unauthorized access, while also simplifying the management of permissions through automated access control mechanisms. Instead of granting access to all team members or those on a listserv, the access manager 250 allows for fine-grained control, ensuring that users only have access to the secrets necessary, for example, in association with their roles, thereby strengthening security and reducing the risk of exposure.

In some embodiments, the access manager 250 performs enforcement of access. In such cases, the access manager 250 may evaluate access requests to secrets in real-time and either grant or deny access based on stored policies. In this case, an access request may be processed directly by the access manager 250, ensuring immediate enforcement of access rules.

In other embodiments, access control decision-making (e.g., allow or deny access to the secrets) from may be performed separate from enforcement. For example, the access manager 250 may evaluate access requests and provide an authorization decision (e.g., allow or deny), but the actual enforcement is handled by an external security module, such as a Policy Enforcement Point or an Identity and Access Management system. Such separation of functionality may enhance scalability and allow for policy changes without modifying secrets manager functionality.

To perform access control, the access manager 250 may identify a requestor of access to a secret(s). Based on identifying the accessing requesting user, the access manager 250 may determine whether requesting user has access to the particular secret. In this way, a policy indicating access, also referred to herein as an access policy, may be referenced and used to determine whether the user has access to the particular secret. An access policy may indicate or define various access control rules, such as roles or users authorized to view, modify, access, use, or manage a secret. An access policy may include allowed roles (e.g., specific roles that can access a secret), allowed users (e.g., specific user accounts permitted to access the secret), access levels, what actions a role or use can perform, such as read, write, delete, etc.), conditions (e.g., additional constraints such as IP restrictions, time-based access, etc.), and/or the like.

In some cases, the access policy may specify a role(s) associated with the requesting user that is required for permitting access to the secret. In this regard, the access manager 250 may verify whether the requesting user has the appropriate role to access a particular secret. To do so, the users may be assigned one or more specific roles, such as “Admin,” “Developer,” or “Read-Only.” In embodiments, the user access policies, or user permissions, may be centralized making it easier for administrators to update access rules dynamically without manually modifying multiple configurations.

As one example, in an organization with separate teams managing different infrastructure components, DevOps engineers may have access to AWS credentials but not database passwords, while developers may retrieve API keys but not encryption keys. Security analysts may only have audit access to track secret usage without the ability to modify secrets. In this regard, in cases in which a developer requests access to an AWS secret, the access manager 250 may check stored policies, determine that the request does not meet access criteria and, as such, deny the request. However, if a DevOps engineer submits the same request, the access manager 250 may verify their role and grants access accordingly.

By way of example, a user or application may request access to a secret (e.g., retrieve a secret). Such a request may include an identification of who is making the request (e.g., user identity and/or role) and an identifier for a secret desired to be accessed. The access manager 250 may verify the identity of the request, for example, using an authentication tool, such as SSO, OAuth, LDAP, Active Directory, etc. In some cases, the access manager 250 may obtain or reference a role(s) associated with the user. The access manager 250 may retrieve a policy for the requested secret. For example, the access manager 250 may look up tags associated with the secret (e.g., Database_Credentials), and a hash map or policy store may be queried to obtain the applicable access policy. Thereafter, the user's identity, role(s), and/or request context may be compared to the target access policy to determine whether access is permitted. For example, a role check may be performed to verify the user's role is an allowed role, a user check may be performed to verify the user is explicitly allowed, a permissions check may be performed to verify the user's role has a requested action permitted (e.g., read), and various conditions may be verified (e.g., IP restrictions, time-based restrictions, and/or the like). In cases in which all attributes pass, access may be granted and the secret provided. On the other hand, in cases in which any of the attributes fail, access may be denied and, in some cases, an appropriate error message returned.

In some cases, the access manager 250 may audit accesses and/or access attempts. In some instances, access manager 250 perform auditing in association with all access or access attempt. In other instances, access manager 250 may perform auditing in cases in which the policy includes an indication to audit. In performing auditing, the access manager 250 may log the access or access attempts. Various types of data may be captured or recorded, such as user identity, time of request, access decision (e.g., granted or denied), conditions checked, etc. Such logs may be stored for various types of security monitoring.

The access manager 250 may provide output data 280 in association with the access management. For example, the status of the access (e.g., allowed or denied) and/or access audit data (e.g., time of access, etc.) may be provided, for example, to a data store or to an access requestor.

Accordingly, the access manager 250 may facilitate compliance with security policies, simplify permission management, and enhance the organization's overall security. In this regard, by implementing dynamic role-based access and centralized policy enforcement, the access manager 250 enables organizations to maintain strict access control without adding operational complexity.

The secret generator 260 is generally configured to generate or create secrets. In particular, the secret generator 260 may automate the process of generating new secrets, for instance, for specific secret types. Such a secret generator 260 enables users to interact directly with the secrets management system, which then triggers the creation of new secrets dynamically. In contrast, in conventional implementations, obtaining a secret generally required interacting with a third-party service responsible for secret generation, onboarding with that service, and manually retrieving the generated secret. Such a conventional implementation is inefficient, involves multiple steps, and is prone to human error, such as neglecting to store or update the secret.

In embodiments, the secret generator 260 may expose a standardized API endpoint, such as/configure or/token, which may serve as a request trigger for secret generation. Accordingly, when a secret generation request is made to this endpoint, the secret generator 260 may identify a corresponding secret type, such as a GitLab secret, and automatically interact with a predefined secret generation service. For example, if a short-lived token is required, such as a JSON Web Token (JWT), the secret generator 260 contacts the appropriate token generation service, retrieves the most recent valid token, and securely stores it within the secrets data store, such as secrets data store 214. Such an implementation ensures that secrets are up to date and eliminates the need for users to manually fetch and manage secrets.

In implementation, multiple layers of authentication and authorization may be executed before allowing generation of a secret(s). For example, in some cases, a secrets manager system may only interact with trusted users who have been authenticated using mechanisms such as vault tokens. A vault token serves as a trust mechanism between the user and the secrets data store, ensuring that only authorized users can request and retrieve secrets. Upon verifying authentication, the secret generator 260 may securely communicate with the secret provider or secrets issuer on behalf of the authenticated user, retrieve the secret, and store it in the designated secret location.

For example, assume a developer needs a new authentication token for a GitLab integration. Instead of requesting the token from a third-party service, the developer interacts with the secrets management system via the secrets manager 212, which automatically initiates generation and retrieves a valid GitLab token. By automating the creation of secrets, the secret generator 260 enhances efficiency, security, and ease of use. It ensures that secrets are available when needed while minimizing human involvement in secrets management, thereby reducing errors and improving overall security.

In embodiments, when a new secret is generated, the secret generator 260 may provide output data 280 in association with the new secret. For example, the secret, and/or data associated therewith, may be provided to a secrets data store, such as secrets data store 214. As another example, an indication of a success or failure of writing data to a data store may be provided (e.g., to a requestor of the secret).

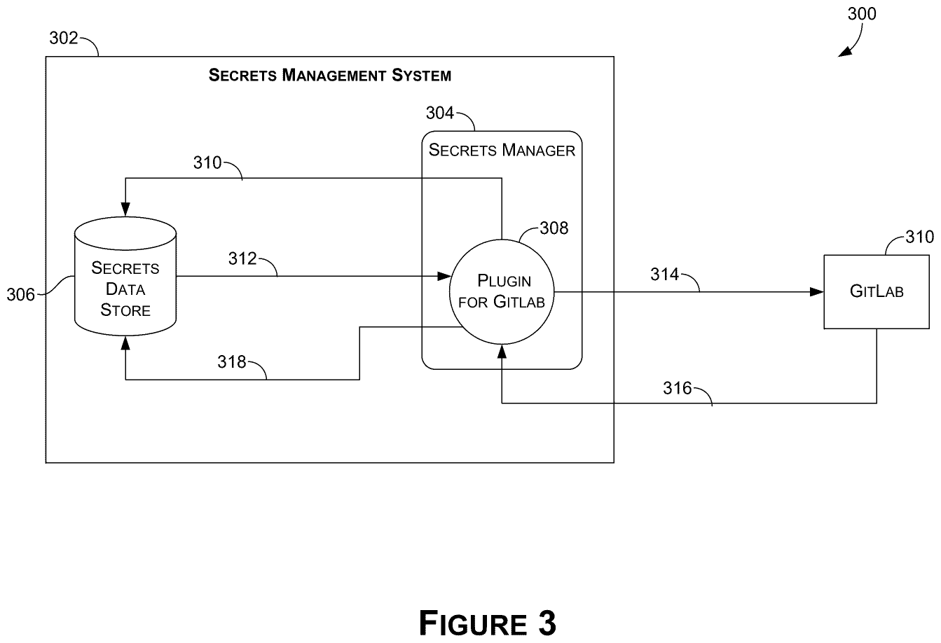

Turning to FIG. 3, FIG. 3 provides an example for performing secrets management. In FIG. 3, a secrets management system 302 includes a secrets manager 304 and a secrets data store 306. As shown, the secrets manager 304 includes a plugin 308. In this example, the plugin 308 may perform the various functionalities discussed in association with the secrets manager 212 of FIG. 2. In one example flow, the plugin 308 may identify 310 when access tokens are expiring based on metadata in/git-tokens path. In response, corresponding secret metadata may be provided 312 to the plugin 308 indicating a last updated time for access tokens. The plugin 308 may then provide a request 314 to GitLab for rotating the appropriate expiring access token(s). In response, GitLab returns 316 a rotated project access token to the plugin 308, which is then provided 318 for updating within the secrets data store 306 (e.g., including the newly rotated token and corresponding metadata).

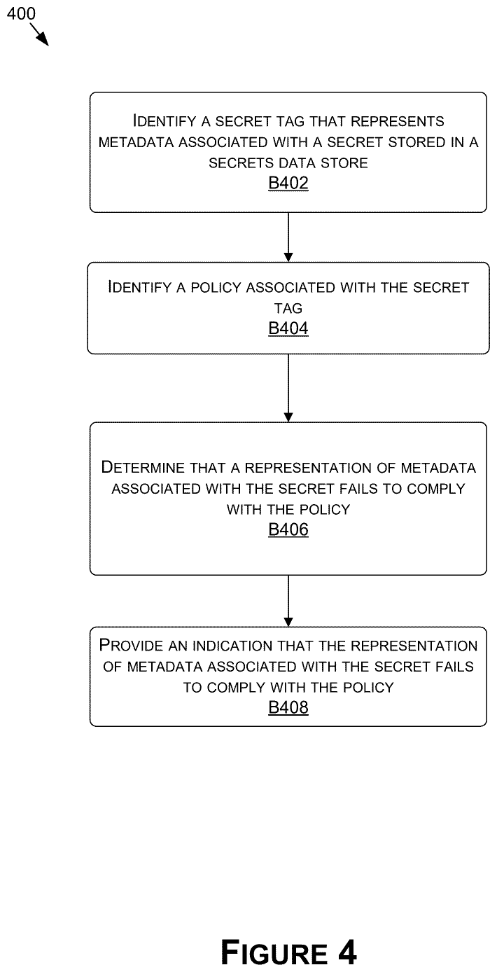

Now referring to FIGS. 4-6, each block of methods 400, 500, and 600 described herein, comprises a computing process that may be performed using any combination of hardware, firmware, and/or software. For instance, various functions may be carried out using one or more processors executing instructions stored in one or more memories. The method may also be embodied as computer-usable instructions stored on computer storage media. The method may be provided by a standalone application, a service or hosted service (standalone or in combination with another hosted service), as a microservice via an application programming interface (API) or a plug-in to another product, to name a few. In addition, methods 400, 500, and 600 are described, by way of example, with respect to the system of FIG. 1 and FIG. 2. However, this method may additionally or alternatively be executed by any one system, or any combination of systems, including, but not limited to, those described herein.

FIG. 4 is a flow diagram showing a method 400 for facilitating management of secrets, in accordance with some embodiments of the present disclosure. The method 400, at block B402, includes identifying a secret tag that represents metadata associated with a secret stored in a secrets data store. In some cases, the secret tag may be selected from a predetermined set of tags that may be applicable or relevant to secrets.

The method 400, at block B404, includes identifying a policy associated with the secret. In embodiments, the policy associated with the secret tag is identified based on a hash map that maps policies to corresponding secret tags. In some cases, identification of the policy may occur based on an expiration of a predetermined time duration. In other cases, identification of the policy may occur based on the secret being generated, modified, accessed, requested, rotated, stored, or deleted. The policy may relate to an access rule, a rotation rule, or the like.

The method 400, at block B406, includes determining that a representation of metadata associated with the secret fails to comply with the policy. For example, assume a policy indicates that a secret of a particular type is to be stored in a particular location. Using metadata associated with the secret, a determination may be made that the secret is not stored in the correct location and, as such, the secret fails to comply with the policy.

The method 400, at block B408, includes providing an indication that the representation of metadata associated with the secret fails to comply with the policy. For example, such an indication may be provided as an alert that is displayed via a user device.

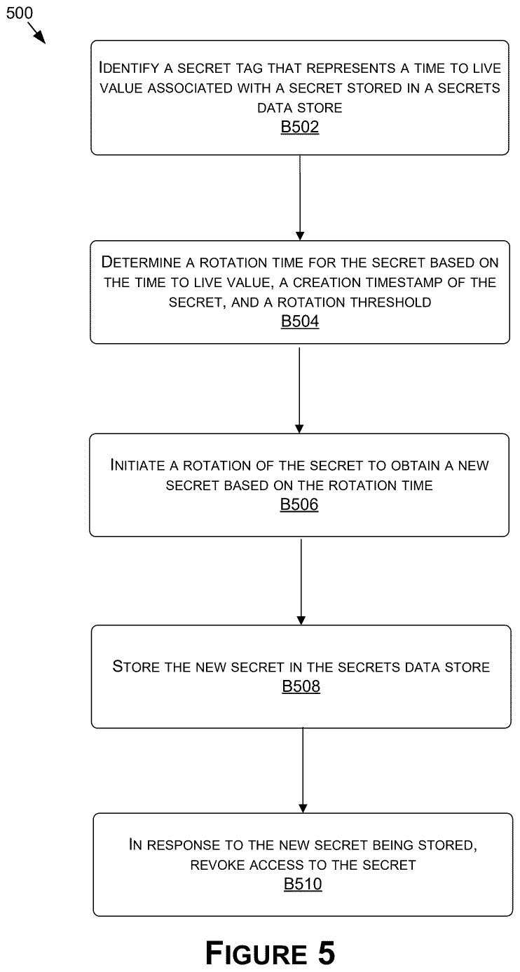

FIG. 5 provides a flow diagram showing a method 500 for facilitating management of secrets, in accordance with some embodiments of the present disclosure. The method 500, at block B502, includes identifying a secret tag that represents a time to live value associated with a secret stored in a secrets data store. For example, a secret tag may represent that a secret corresponds with a 60 day time to live.

The method 500, at block B504, includes determining a rotation time for the secret based on the time to live value, a creation timestamp of the secret, and a rotation threshold. In embodiments, to determine a rotation time, an expiration time may be determined by adding the time to live to the creation time of the secret. Thereafter, the rotation time may be determined by reducing the expiration time by a rotation threshold. In some cases, the original secret may be valid between the expiration time and the rotation time to allow users to update the secrets on corresponding services with the newly rotated secret. Once the expiration time has passed, the secret may automatically be deleted and replaced by the rotated secret. The values of the time to live and the rotation threshold may be retrieved from a configuration file created for or associated with the secrets manager, or portion there (e.g., plugin).

The method 500, at block B506, includes initiating a rotation of the secret to obtain a new secret based on the rotation time. In some cases, initiating rotation of the secret comprises requesting the new secret from a secrets issuer. The method 500, at block B508, includes storing the new secret in the secrets data store. The method 500, at block B510, includes, in response to the new secret being stored, revoke access to the secret. In some cases, the access revocation may occur immediately. In other cases, a particular amount of time may exist until the access is revoked or the access may be revoked at the expiration time of the secret.

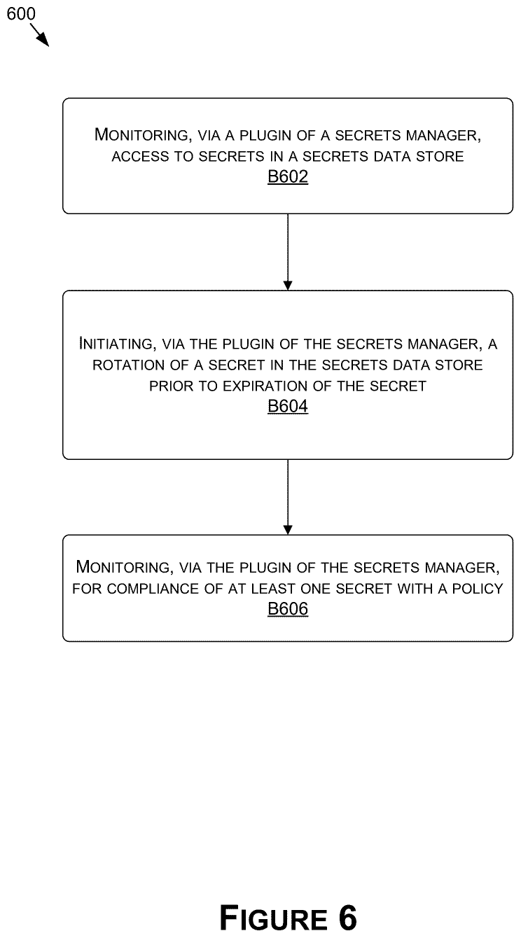

Turning to FIG. 6, FIG. 6 provides a flow diagram showing a method 600 for facilitating management of secrets, in accordance with some embodiments of the present disclosure. The method 600, at block B602, includes monitoring, via a plugin of a secrets manager, access to secrets in a secrets data store. Access to secrets may be monitored in an ongoing manner such that unauthorized access may be identified. In this way, when unauthorized access is identified, the user is prevented from accessing the secret.

The method 600, at block B604, includes initiating, via the plugin of the secrets manager, a rotation of a secret in a secrets data store prior to expiration of the secret. In this way, the plugin is actively monitoring timing for rotating secrets such that secrets are rotated automatically in advance of expiration.

The method 600, at block B606, includes monitoring, via the plugin of the secrets manager, for compliance of at least one secret with a policy. For example, a policy applicable to a secret may be identified, and metadata associated with the secret may be compared to the policy to determine whether the secret is compliant with the policy. In this way, policies may be enforced via the plugin in a secret and effective manner.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models-such as one or more large language models (LLMs), one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

In some embodiments, the system and methods described herein may be deployed in a talking or smart kiosk application. For example, a kiosk, tablet, smart display, or other device may include one or more onboard processors (e.g., CPUs, GPUs, deep learning accelerators, SoCs) and memory and/or storage (e.g., for storing the model, the image database, etc.). In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with the machine learning model(s) (e.g., language model, LLM, SLM, VLM, MMLM, diffusion model, transformer model, NeRF, DNN, etc.) and/or the image database hosted on the local and/or remote servers using one or more APIs-such as, without limitation, REST APIs.

In one or more embodiments, the system and methods described herein may be deployed in a gaming application. For example, a gaming console, PC, tablet, or other gaming device may include one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., diffusion models, transformer models, neural rendering field (NeRF) models, language models (e.g., LLMs, SLMs, VLMs, MMLMs, etc.), DNNs, etc.) to enhance gameplay, generate real-time dynamic content, aid in collaboration or team efforts among teams, and/or personalize user experiences based on in-game behavior or pre-stored player profiles. In some embodiments, the system may be deployed in a cloud gaming environment (e.g., NVIDIA's GeFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used.

In some embodiments, the system and methods described herein may be deployed in a video conferencing application. For example, a video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). The system may use the machine learning model(s) (e.g., diffusion models, transformer models, neural rendering field (NeRF) models, language models (e.g., LLMs, SLMs, VLMs, MMLMs, etc.)) to enhance video conferencing functionality, including real-time or near real-time transcription, diarization, language translation, automatic speech recognition (ASR), and/or background noise reduction. In one or more embodiments, the system may enable users to interact with the video conferencing platform using natural language inputs. For example, users may issue voice commands to schedule, join, or leave meetings, or to manage participants and screen sharing. During receiving and/or sending the data to and from the end-user or edge device(s), one or more data processing units (DPUs) and/or network interface cards (NICs) may be used.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)-which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, SLMs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)-which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

### Example Computing Device

FIG. 9 is a block diagram of an example computing device(s) 900 suitable for use in implementing some embodiments of the present disclosure. Computing device 900 may include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one embodiment, the computing device(s) 900 may comprise one or more virtual machines (VMs), and/or any of the components thereof may comprise virtual components (e.g., virtual hardware components). For non-limiting examples, one or more of the GPUs 908 may comprise one or more vGPUs, one or more of the CPUs 906 may comprise one or more vCPUs, and/or one or more of the logic units 920 may comprise one or more virtual logic units. As such, a computing device(s) 900 may include discrete components (e.g., a full GPU dedicated to the computing device 900), virtual components (e.g., a portion of a GPU dedicated to the computing device 900), or a combination thereof.

Although the various blocks of FIG. 9 are shown as connected via the interconnect system 902 with lines, this is not intended to be limiting and is for clarity only. For example, in some embodiments, a presentation component 918, such as a display device, may be considered an I/O component 914 (e.g., if the display is a touch screen). As another example, the CPUs 906 and/or GPUs 908 may include memory (e.g., the memory 904 may be representative of a storage device in addition to the memory of the GPUs 908, the CPUs 906, and/or other components). As such, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 may represent one or more links or busses, such as an address bus, a data bus, a control bus, or a combination thereof. The interconnect system 902 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 906 may be directly connected to the memory 904. Further, the CPU 906 may be directly connected to the GPU 908. Where there is direct, or point-to-point connection between components, the interconnect system 902 may include a PCIe link to carry out the connection. In these examples, a PCI bus need not be included in the computing device 900.

The memory 904 may include any of a variety of computer-readable media. The computer-readable media may be any available media that may be accessed by the computing device 900. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 904 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 900. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 906 may be configured to execute at least some of the computer-readable instructions to control one or more components of the computing device 900 to perform one or more of the methods and/or processes described herein. The CPU(s) 906 may each include one or more cores (e.g., one, two, four, eight, twenty-eight, seventy-two, etc.) that are capable of handling a multitude of software threads simultaneously. The CPU(s) 906 may include any type of processor, and may include different types of processors depending on the type of computing device 900 implemented (e.g., processors with fewer cores for mobile devices and processors with more cores for servers). For example, depending on the type of computing device 900, the processor may be an Advanced RISC Machines (ARM) processor implemented using Reduced Instruction Set Computing (RISC) or an x86 processor implemented using Complex Instruction Set Computing (CISC). The computing device 900 may include one or more CPUs 906 in addition to one or more microprocessors or supplementary co-processors, such as math co-processors.

In addition to or alternatively from the CPU(s) 906, the GPU(s) 908 may be configured to execute at least some of the computer-readable instructions to control one or more components of the computing device 900 to perform one or more of the methods and/or processes described herein. One or more of the GPU(s) 908 may be an integrated GPU (e.g., with one or more of the CPU(s) 906 and/or one or more of the GPU(s) 908 may be a discrete GPU. In embodiments, one or more of the GPU(s) 908 may be a coprocessor of one or more of the CPU(s) 906. The GPU(s) 908 may be used by the computing device 900 to render graphics (e.g., 3D graphics) or perform general purpose computations. For example, the GPU(s) 908 may be used for General-Purpose computing on GPUs (GPGPU). The GPU(s) 908 may include hundreds or thousands of cores that are capable of handling hundreds or thousands of software threads simultaneously. The GPU(s) 908 may generate pixel data for output images in response to rendering commands (e.g., rendering commands from the CPU(s) 906 received via a host interface). The GPU(s) 908 may include graphics memory, such as display memory, for storing pixel data or any other suitable data, such as GPGPU data. The display memory may be included as part of the memory 904. The GPU(s) 908 may include two or more GPUs operating in parallel (e.g., via a link). The link may directly connect the GPUs (e.g., using NVLINK) or may connect the GPUs through a switch (e.g., using NVSwitch). When combined together, each GPU 908 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 906 and/or the GPU(s) 908, the logic unit(s) 920 may be configured to execute at least some of the computer-readable instructions to control one or more components of the computing device 900 to perform one or more of the methods and/or processes described herein. In embodiments, the CPU(s) 906, the GPU(s) 908, and/or the logic unit(s) 920 may discretely or jointly perform any combination of the methods, processes and/or portions thereof. One or more of the logic units 920 may be part of and/or integrated in one or more of the CPU(s) 906 and/or the GPU(s) 908 and/or one or more of the logic units 920 may be discrete components or otherwise external to the CPU(s) 906 and/or the GPU(s) 908. In embodiments, one or more of the logic units 920 may be a coprocessor of one or more of the CPU(s) 906 and/or one or more of the GPU(s) 908.

Examples of the logic unit(s) 920 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 910 may include one or more receivers, transmitters, and/or transceivers that allow the computing device 900 to communicate with other computing devices via an electronic communication network, included wired and/or wireless communications. The communication interface 910 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 920 and/or communication interface 910 may include one or more data processing units (DPUs) to transmit data received over a network and/or through interconnect system 902 directly to (e.g., a memory of) one or more GPU(s) 908.

The I/O ports 912 may allow the computing device 900 to be logically coupled to other devices including the I/O components 914, the presentation component(s) 918, and/or other components, some of which may be built in to (e.g., integrated in) the computing device 900. Illustrative I/O components 914 include a microphone, mouse, keyboard, joystick, game pad, game controller, satellite dish, scanner, printer, wireless device, etc. The I/O components 914 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 may be include depth cameras, such as stereoscopic camera systems, infrared camera systems, RGB camera systems, touchscreen technology, and combinations of these, for gesture detection and recognition. Additionally, the computing device 900 may include accelerometers or gyroscopes (e.g., as part of an inertia measurement unit (IMU)) that allow detection of motion. In some examples, the output of the accelerometers or gyroscopes may be used by the computing device 900 to render immersive augmented reality or virtual reality.

The power supply 916 may include a hard-wired power supply, a battery power supply, or a combination thereof. The power supply 916 may provide power to the computing device 900 to allow the components of the computing device 900 to operate.

The presentation component(s) 918 may include a display (e.g., a monitor, a touch screen, a television screen, a heads-up-display (HUD), other display types, or a combination thereof), speakers, and/or other presentation components. The presentation component(s) 918 may receive data from other components (e.g., the GPU(s) 908, the CPU(s) 906, DPUs, etc.), and output the data (e.g., as an image, video, sound, etc.).

### Example Data Center

FIG. 10 illustrates an example data center 1000 that may be used in at least one embodiments of the present disclosure. The data center 1000 may include a data center infrastructure layer 1010, a framework layer 1020, a software layer 1030, and/or an application layer 1040.

As shown in FIG. 10, the data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1016(1)-1016(N) may correspond to a server having one or more of the above-mentioned computing resources. In addition, in some embodiments, the node C.R.s 1016(1)-10161(N) may include one or more virtual components, such as vGPUs, vCPUs, and/or the like, and/or one or more of the node C.R.s 1016(1)-1016(N) may correspond to a virtual machine (VM).

In at least one embodiment, grouped computing resources 1014 may include separate groupings of node C.R.s 1016 housed within one or more racks (not shown), or many racks housed in data centers at various geographical locations (also not shown). Separate groupings of node C.R.s 1016 within grouped computing resources 1014 may include grouped compute, network, memory or storage resources that may be configured or allocated to support one or more workloads. In at least one embodiment, several node C.R.s 1016 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1012 may configure or otherwise control one or more node C.R.s 1016(1)-1016(N) and/or grouped computing resources 1014. In at least one embodiment, resource orchestrator 1012 may include a software design infrastructure (SDI) management entity for the data center 1000. The resource orchestrator 1012 may include hardware, software, or some combination thereof.

In at least one embodiment, as shown in FIG. 10, framework layer 1020 may include a job scheduler 1028, a configuration manager 1034, a resource manager 1036, and/or a distributed file system 1038. The framework layer 1020 may include a framework to support software 1032 of software layer 1030 and/or one or more application(s) 1042 of application layer 1040. The software 1032 or application(s) 1042 may respectively include web-based service software or applications, such as those provided by Amazon Web Services, Google Cloud and Microsoft Azure. The framework layer 1020 may be, but is not limited to, a type of free and open-source software web application framework such as Apache Spark™ (hereinafter “Spark”) that may use distributed file system 1038 for large-scale data processing (e.g., “big data”). In at least one embodiment, job scheduler 1028 may include a Spark driver to facilitate scheduling of workloads supported by various layers of data center 1000. The configuration manager 1034 may be capable of configuring different layers such as software layer 1030 and framework layer 1020 including Spark and distributed file system 1038 for supporting large-scale data processing. The resource manager 1036 may be capable of managing clustered or grouped computing resources mapped to or allocated for support of distributed file system 1038 and job scheduler 1028. In at least one embodiment, clustered or grouped computing resources may include grouped computing resource 1014 at data center infrastructure layer 1010. The resource manager 1036 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1034, resource manager 1036, and resource orchestrator 1012 may implement any number and type of self-modifying actions based on any amount and type of data acquired in any technically feasible fashion. Self-modifying actions may relieve a data center operator of data center 1000 from making possibly bad configuration decisions and possibly avoiding underutilized and/or poor performing portions of a data center.

The data center 1000 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1000. In at least one embodiment, trained or deployed machine learning models corresponding to one or more neural networks may be used to infer or predict information using resources described above with respect to the data center 1000 by using weight parameters calculated through one or more training techniques, such as but not limited to those described herein.

In at least one embodiment, the data center 1000 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 900 of FIG. 9—e.g., each device may include similar components, features, and/or functionality of the computing device(s) 900. In addition, where backend devices (e.g., servers, NAS, etc.) are implemented, the backend devices may be included as part of a data center 1000, an example of which is described in more detail herein with respect to FIG. 10.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments-in which case a server may not be included in a network environment—and one or more client-server network environments-in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 900 described herein with respect to FIG. 9. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
identify a secret tag that represents metadata associated with a secret stored in a secrets data store;
identify a policy associated with the secret tag;
determine that a representation of metadata associated with the secret fails to comply with the policy; and
provide an indication that the representation of metadata associated with the secret fails to comply with the policy.

2. The one or more processors of claim 1, wherein the processing circuitry further to cause presentation, using at least one of a display device or a sound device, of the indication that the representation of the metadata associated with the secret fails to comply with the policy.

3. The one or more processors of claim 1, wherein the policy associated with the secret tag is identified based on a hash map that maps policies to corresponding secret tags.

4. The one or more processors of claim 1, wherein the policy associated with the secret tag is identified based on an expiration of a predetermined time duration.

5. The one or more processors of claim 1, wherein the policy associated with the secret tag is identified based on the secret being at least one of generated, modified, accessed, requested, rotated, stored, or deleted.

6. The one or more processors of claim 1, wherein the policy comprises a policy that represents an access rule.

7. The one or more processors of claim 6, wherein determining that the representation of metadata associated with the secret fails to comply with the policy comprises:
identifying a requestor of access to the secret; and
determining whether the requestor of access has access to the secret based on the policy.

8. The one or more processors of claim 7, wherein determining whether the requestor of access has access to the secret is further based on a role, within an organization, associated with the request of access to the secret.

9. The one or more processors of claim 1, wherein the policy comprises a policy that represents a rotation rule.

10. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

11. A system comprising one or more processors to:
identify a secret tag that represents a time to live value associated with a secret stored in a secrets data store;
determine a rotation time for the secret based on the time to live value, a creation timestamp of the secret, and a rotation threshold;
initiate, based on the rotation time, a rotation of the secret to obtain a new secret; and
store the new secret in the secrets data store and, in response to the new secret being stored, revoke access to the secret.

12. The system of claim 11, wherein to determine the rotation time, the one or more processors are further to:
determine an expiration time based on the time to live value associated with the secret added to the creation time of the secret; and
remove the rotation threshold from the expiration time to generate the rotation time.

13. The system of claim 11, wherein to initiate the rotation of the secret, the one or more processors are further to request the new secret from a secrets issuer.

14. The system of claim 11, wherein the one or more processors are further to determine and store metadata associated with the new secret, wherein the secret tag is identified based on the metadata.

15. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

16. A method comprising:
monitoring, via a plugin of a secrets manager, access to secrets in a secrets data store;
initiating, via the plugin of the secrets manager, a rotation of a secret in the secrets data store prior to expiration of the secret; and
monitoring, via the plugin of the secrets manager, for compliance of at least one secret with a policy.

17. The method of claim 16, further comprising enforcing access to the secrets in the secrets data store based on authorized users.

18. The method of claim 17, wherein the authorized users are determined based on roles associated with users.

19. The method of claim 16, wherein the rotation of the secret is performed at a predetermined time in advance of the expiration of the secret.

20. The method of claim 16, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.
